(19) United States
(12) Patent Application Publication
(10) Pub. No.: US 2006/0192413 A1
(43) Pub. Date: Aug. 31, 2006

(54) Ventilator-glare screen unit

(76) Inventor: David Yang, Moraga, CA (US)

Correspondence Address: DAVID YANG, 1020 WICKHAM DR., MORAGA, CA, 94556, US

(21) Appl. No.: 11/068,455

(22) Filed: Feb. 28, 2005

(51) Int. Cl. B60J 7/00

(52) U.S. Cl. 296/214

(57) ABSTRACT

The ventilator-glare screen unit of present invention is to replace the conventional sun shed in vehicle's sun roof assembly in prior art. It comprises of two planar pieces, in which one of the planar pieces has an integral sun screen. The unit is operable in various modes in conjunction with the motor driven glass pane in the sun roof assembly. Consequently, the unit provides full or moderate air venting and sun light transmission during driving, and essential air venting for a parked vehicle.

### BACKGROUND OF THE INVENTION

The present invention relates to a ventilator-glare screen unit operable in conjunction with a glass pane in a vehicle's sun roof assembly.

The conventional sun roof assembly in prior art has four basic elements: an exterior roof opening, an interior roof opening, a motor driven glass pane, and a sun shed. The glass pane and sun shed are made of glass panel and solid panel respectively. The sun roof assembly in prior art is operable in four basic operation modes: (1). The first closing mode that has both glass pane and sun shed placed at close positions to cover exterior and interior roof openings respectively. In this mode, air venting and sun light transmission through sun roof assembly are prohibited. (2). The second closing mode that has glass pane placed at close position to cover exterior roof opening, but sun shed placed at open position to uncover interior roof opening. In this mode, air venting through sun roof assembly is prohibited, but interior of vehicle is subject to full sun light exposure. (3). The opening mode that has both glass pane and sun shed placed at open positions to uncover both exterior and interior roof openings. In this mode, interior of vehicle is subject to full blow of air flow and full sun light exposure during driving. (4). The vent mode that has sun shed placed at open position, but glass pane placed at tilted position to slightly uncover exterior roof opening. In this mode, interior of vehicle is subject to moderate air venting but full sun light exposure.

The author of present invention found that the sun roof assembly in prior art does not provide sufficient operation modes to meet the demand for more comfortable driving conditions. Because: (1). In the second closing mode, moderate rather than full sun light exposure may also be desirable. (2). In the opening mode, moderate rather than fill air flow and sun light exposure may also be desirable. (3). In the vent mode, moderate rather than full sun light exposure may also be desirable.

The author of present invention also found that, due to car theft or vandalism concern, the above opening mode or vent mode is not suitable for ventilating a parked car when the parked car is not attended. A parked car exposed under the sun can experience an extremely high interior temperature as resulted of full closure of windows. Such high temperature not only causes an uncomfortable condition for entering a parked car, but also causes a life threatening condition as if a child or pet being confined alone in a parked car.

For purpose of ventilating a parked car, a variety of ventilating devices in prior art have been proposed for installation in partially opened windows. However, they are not only vulnerable to vandalism or car theft, but also having drawbacks such as difficulty and complexity for installation and removal, high cost, and unattractive appearance, etc.

Therefore, there is a need to improve the sun roof assembly in prior art not only to meet the demand for more comfortable driving conditions, but also the demand for ventilating a parked car. Both objects can be achieved by replacing the sun shed in the sun roof assembly of prior art with the ventilator-glare screen unit of present invention.

### SUMMARY OF THE INVENTION

The object of the invention is to provide the sun roof assembly in a vehicle with a ventilator-glare screen unit that is operable in conjunction with the glass pane in the sun roof assembly.

Another object of the invention is to provide such a ventilator-glare screen unit that is capable of providing interior of vehicle with full or moderate sun light exposure.

Another object of the invention is to provide such a ventilator-glare screen unit that is capable of providing interior of vehicle with full or moderate air venting.

Another object of the invention is to provide a ventilator-glare screen unit that is capable of ventilating a parked car without a security concern.

### BRIEF DESCRIPTION OF THE DRAWINGS

FIG. 1 is a top perspective view of the first preferred embodiment of the ventilator-glare screen unit of present invention in a dissembled state.

FIG. 2 is a bottom perspective view of the first preferred embodiment of the ventilator-glare screen unit of present invention in a dissembled state.

FIG. 3 is a top perspective view of the first preferred embodiment of the ventilator-glare screen unit of present invention assembled into a coupled unit during a closing mode.

FIG. 4 is a bottom perspective view of the first preferred embodiment of the ventilator-glare screen unit of present invention assembled into a coupled unit during a closing mode.

FIG. 5 is a top perspective view of the first preferred embodiment of the ventilator-glare screen unit of present invention assembled into a de-coupled unit during an opening mode.

FIG. 6 is a bottom perspective view of the first preferred embodiment of the ventilator-glare screen unit of present invention assembled into a de-coupled unit during an opening mode.

FIG. 7 is a top perspective view of the second preferred embodiment of the ventilator-glare screen unit of present invention in a dissembled state.

FIG. 8 is a bottom perspective view of the second preferred embodiment of the ventilator-glare screen unit of present invention in a dissembled state.

FIG. 9 is a top perspective view of the second preferred embodiment of the ventilator-glare screen unit of present invention assembled into a coupled unit during a closing mode.

FIG. 10 is a bottom perspective view of the second preferred embodiment of the ventilator-glare screen unit of present invention assembled into a coupled unit during a closing mode.

FIG. 11 is a top perspective view of the second preferred embodiment of the ventilator-glare screen unit of present invention assembled into a de-coupled unit during an opening mode.

FIG. 12 is a bottom perspective view of the second preferred embodiment of the ventilator-glare screen unit of present invention assembled into a de-coupled unit during an opening mode.

FIG. 13 is a top perspective view of the third preferred embodiment of the ventilator-glare screen unit of present invention in a dissembled state.

FIG. 14 is a bottom perspective view of the third preferred embodiment of the ventilator-glare screen unit of present invention in a dissembled state.

FIG. 15 is a top perspective view of the third preferred embodiment of the ventilator-glare screen unit of present invention assembled into a coupled unit during a closing mode.

FIG. 16 is a bottom perspective view of the third preferred embodiment of the ventilator-glare screen unit of present invention assembled into a coupled unit during a closing mode.

FIG. 17 is a top perspective view of the third preferred embodiment of the ventilator-glare screen unit of present invention assembled into a de-coupled unit during an opening mode.

FIG. 18 is a bottom perspective view of the third preferred embodiment of the ventilator-glare screen unit of present invention assembled into a de-coupled unit during an opening mode.

### DETAILED DESCRIPTION OF THE PREFERRED EMBODIMENTS

The conventional sun roof assembly in prior art comprises of an exterior roof opening, an interior roof opening, a glass pane slidable along a first pair of parallel tracks mounted in the roof of vehicle, and a sun shed slidable along a second pair of parallel tracks mounted in the roof of vehicle. The ventilator-glare screen unit of present invention is to replace the sun shed in the sun roof assembly in prior art, so that it is operable in conjunction with the glass pane in the sun roof assembly. The glass pane is motor driven forward to a close position to cover exterior roof opening, and rearward to an open position to uncover exterior roof opening. Glass pane can also be motor driven to a vent position with the rear end of glass pane being tilted upward to uncover exterior roof opening.

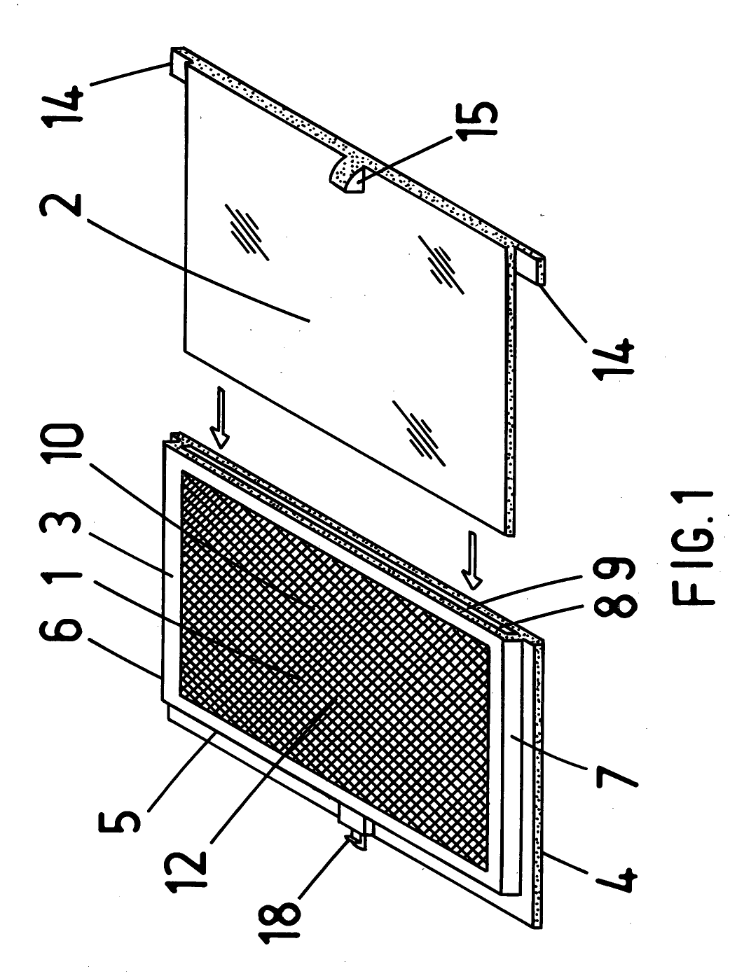

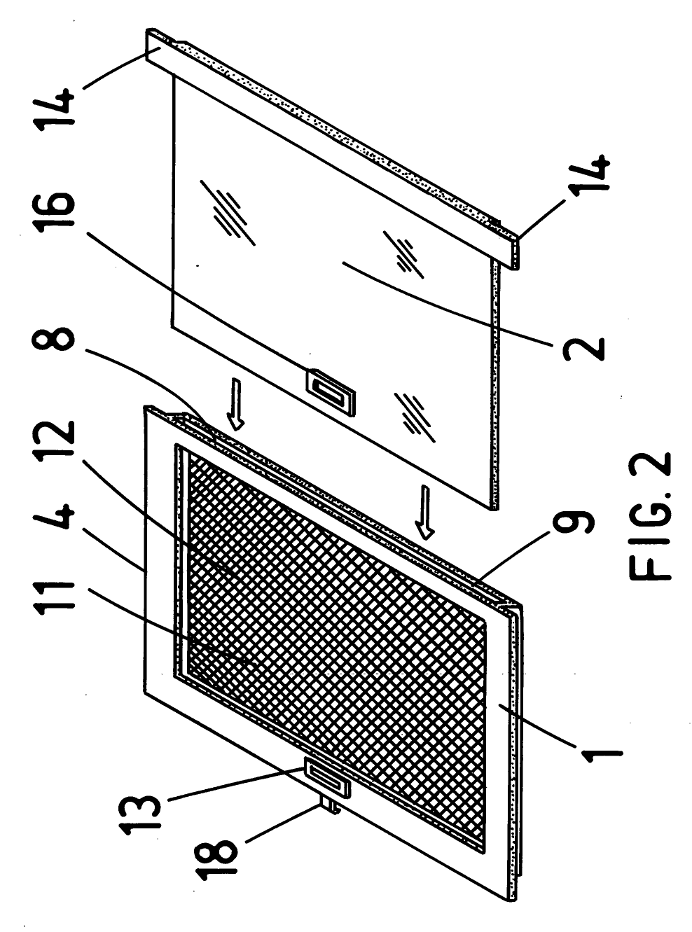

The first preferred embodiment of the ventilator-glare screen unit of present invention is represented in FIG. 1 through FIG. 6. FIG. 1 and FIG. 2 show respectively a top and bottom perspective views of the first preferred embodiment of the ventilator-glare screen unit of present invention in a dissembled state. The ventilator-glare screen unit comprises of a first planar piece 1 and a second planar piece 2, which are independently slidable in a second pair of parallel tracks mounted in the roof of vehicle (not shown).

The first planar piece 1 is made of an integral housing structure with a top wall 3, a bottom wall 4, a front side wall 5, a right side wall 6, and a left side wall 7 that are integrally connected to envelope an inner spacing 8 and a rear side opening 9. The top and bottom walls 3 and 4 are in a substantially rectangular shape and in a size substantially equivalent to that of interior roof opening. A substantially large central area in top wall 3 and bottom wall 4 is cut off to form a top wall opening 10 and a bottom wall opening 11 respectively. The top wall opening 10 is covered by a sun screen 12, which is made of a single layer or multiple layers of permeable material such as rigid wire cloth for air venting. For clarity of drawing, installation details of sun screen 12 covering top wall opening 10 are not shown. Alternatively, sun screen 12 can be made of integral part of top wall 3 that is provided with numbers of vent holes penetrating through for air venting. The first planar piece 1 is slidable along the second pair of parallel tracks by pulling a first pull handle 13 embedded in bottom wall 4. The entire housing structure of first planar piece 1 can be made from fabricating sheet metal or plastic molding.

The second planar piece 2 is made of a solid metal or plastic panel that fits nicely within the inner spacing 8 of first planar piece 1, and between sun screen 12 and bottom wall opening 11 of first planar piece 1. The second planar piece 2 is slidable in and out of inner spacing 8 of first planar piece 1 through the rear side opening 9 of first planar piece 1. A guide 14 and a latch 15 are provided at the rear section of second planar piece 2. The guide 14 is a lateral and downward projectile of second planar piece 2 that fits within the second pair of parallel tracks. The guide 14 allows the rear end of second planar piece 2 to slide in the second pair of parallel tracks when second planar piece 2 slides in and out of inner spacing 8 of first planar piece 1. The latch 15 is an upward projectile of second planar piece 2. The latch 15 is to be engaged with a catcher in the motor driven glass pane when the glass pane moving rearward toward an open position. Consequently, second planar piece 2 and glass pane moving rearward simultaneously. The second planar piece 2 is sildable in and out of inner spacing 8 of first planar piece 1 by pulling a second pull handle 16 embedded in the bottom surface of second planar piece 2.

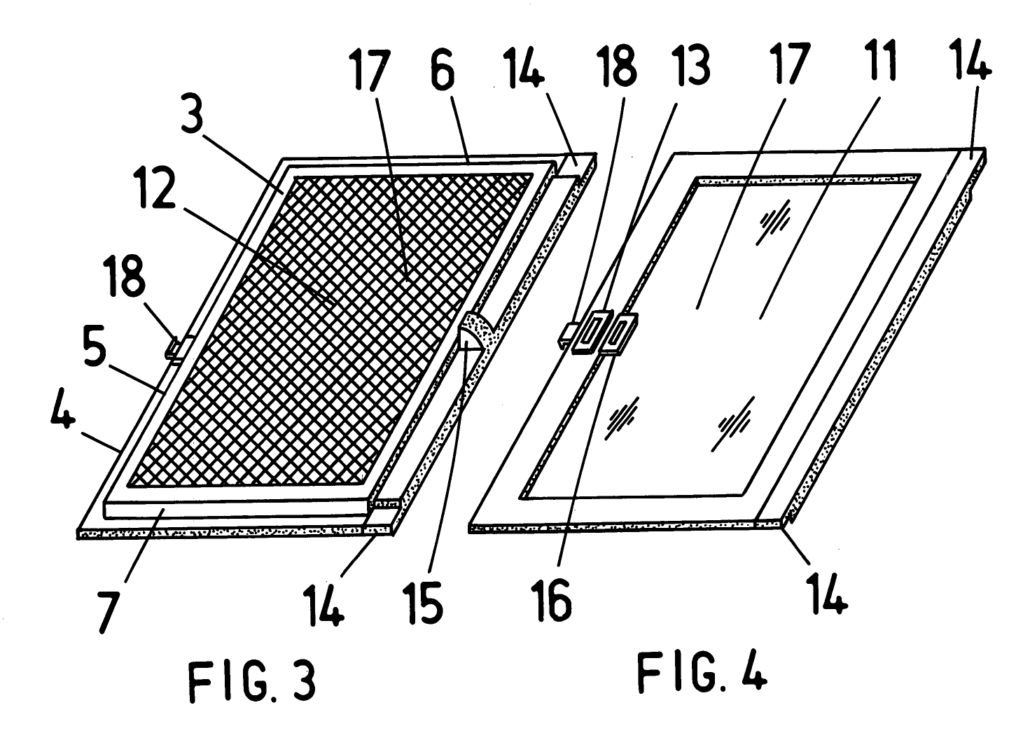

The ventilator-glare screen unit of the first preferred embodiment of present invention is operable in a closing mode when first and second planar pieces 1 and 2 are aligned and interposed vertically into a coupled unit 17 as shown in FIG. 3 (i.e. top view) and FIG. 4 (i.e. bottom view). The coupled unit 17 prohibits air venting and sun light transmission through sun screen 12 and bottom wall opening 11. The size of coupled unit 17 is sufficient to cover the entire interior roof opening.

A locking mechanism 18 is incorporated into the first pull handle 13 of first planar piece 1. Locking mechanism 18 locks the first planar piece 1 at close position to cover the interior roof opening (i.e., locked-close). The locking mechanism 18 is automatically released while first pull handle 13 is pressed.

It is understood that sun screen 12, guide 14, latch 15, first pull handle 13, second pull handle 16, and locking mechanism 18 can be constructed in various configuration for use in the present invention. It is not the intend of present invention to describe the installation details of these components. Any variation in installation or material of these components is considered within the scope of present invention.

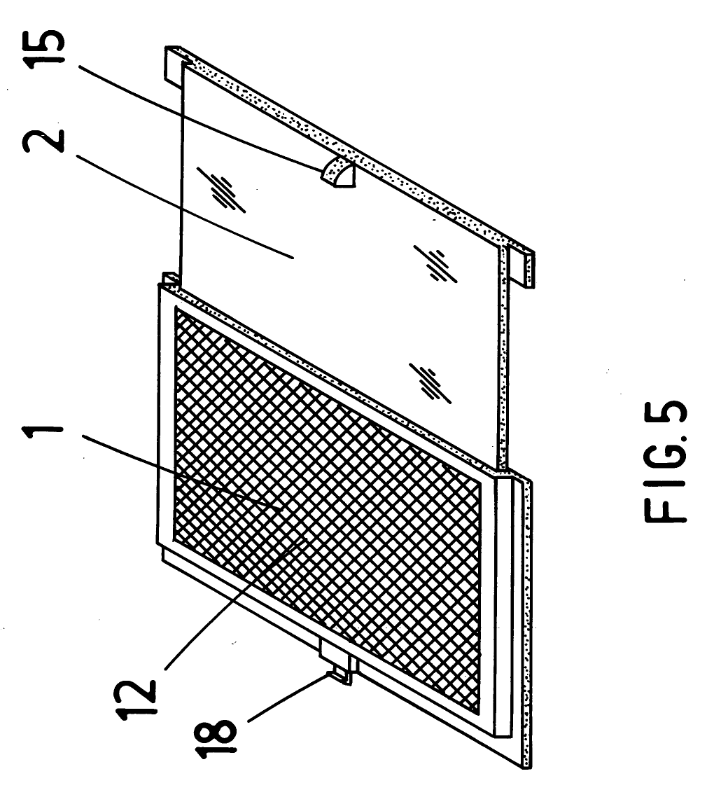

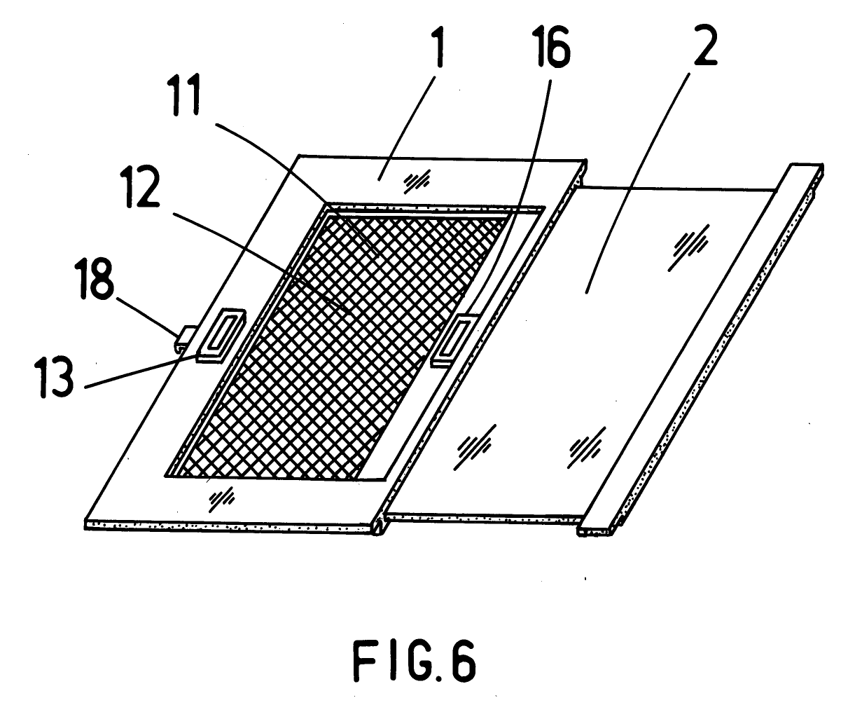

The ventilator-glare screen unit of the first preferred embodiment of present invention is operable in an opening mode as a de-coupled unit as shown in FIG. 5 (i.e. top view) and FIG. 6 (i.e. bottom view), in which planar pieces 1 and 2 are positioned offset to allow air venting and sun light transmission through sun screen 12 and bottom wall opening 11 successively. When the ventilator-glare screen unit operates in the opening mode above the interior roof opening, first planar piece 1 is moved forward to a first front-limit position directly above interior roof opening, and second planar piece 2 is moved rearward to a second rear-limit position offset from interior roof opening. As a result, sun screen 12 and bottom wall opening 11 of first planar piece 1 are positioned directly above interior roof opening, and the second planar piece 2 is positioned offset from sun screen 12 and bottom wall opening 11 of first planar piece 1, as well as offset from interior roof opening. Therefore, air venting and sun light transmission are allowed through sun screen 12 and bottom opening 11 of first planar piece 1, and through interior roof opening successively.

When the ventilator-glare screen unit operates in a closing mode above the interior roof opening, first planar piece 1 is moved forward to a first front-limit position, and second planar piece 2 is moved forward to a second front-limit position. The first and second planar pieces 1 and 2 are aligned and interposed vertically into the coupled unit 14 directly above interior roof opening that covers the entire interior roof opening. Therefore, air venting and sun light transmission through interior roof opening are prohibited. The second pair of parallel tracks is provided with a first stopper that prevents first planar piece from moving forward beyond the first front-limit position.

When the ventilator-glare screen unit operates in a stowed mode above the interior roof opening, first planar piece 1 is moved rearward to a first rear-limit position, and second planar piece 2 is moved rearward to a second rear-limit position. The first and second planar pieces 1 and 2 are aligned and interposed vertically into the coupled unit 14 that is positioned offset from interior opening. Therefore, interior roof opening is left open, and air venting and sun light transmission through interior roof opening are allowed. The second pair of parallel tracks is provided with a second stopper that prevents second planar piece 2 from moving rearward beyond the second rear-limit position.

Ventilator-glare screen unit according to the first preferred embodiment of present invention is operable:

(1). from closing mode to stowed mode by pulling first pull handle 13 rearward so that first and second planar pieces 1 and 2 are moved rearward simultaneously as the coupled unit 14.

(2). from stowed mode to closing mode by pulling second pull handle 16 forward so that first and second planar pieces 1 and 2 are moved forward simultaneously as the coupled unit 14.

(3). from closing mode to opening mode by pulling second pull handle 16 rearward, provided glass pane is not actuated or motor driven to open position. However, ventilator-glare screen unit is operable from closing mode to opening mode automatically without any manual action, provided glass pane is actuated and motor driven to open position.

(4). from opening mode to closing mode by pulling second pull handle 16 forward.

(5). from opening mode to stowed mode by pulling first pull handle 13 rearward.

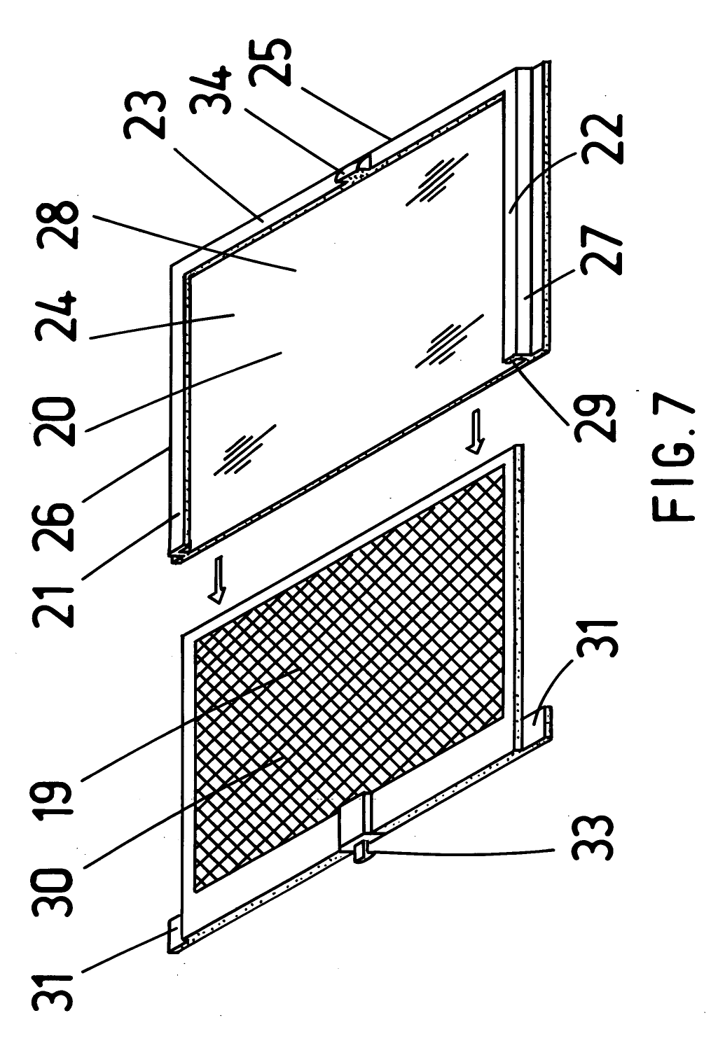

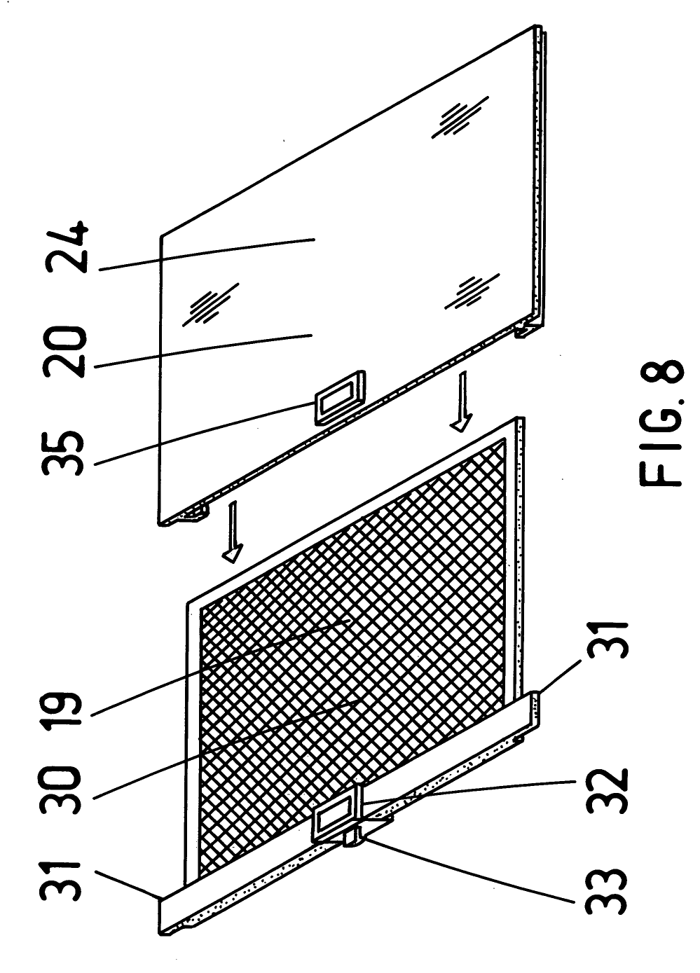

The second preferred embodiment of the ventilator-glare screen unit of present invention is represented in FIG. 7 through FIG. 12. FIG. 7 and FIG. 8 respectively show a top and bottom perspective views of the second preferred embodiment of the ventilator-glare screen unit of present invention in a dissembled state. The ventilator-glare screen unit comprises of a first planar piece 19 and a second planar piece 20, which are independently slidable in a second pair of parallel tracks mounted in the roof of vehicle (not shown).

The second planar piece 20 is made of an integral housing structure with a right top wall 21, a left top wall 22, a rear top wall 23, a bottom wall 24, a rear side wall 25, a right side wall 26, and a left side wall 27, which are integrally connected to envelope an inner spacing 28 and a front side opening 29. The bottom wall 24 is in a substantially rectangular shape and in a size substantially equivalent to that of interior roof opening. The entire housing structure of second planar piece 20 can be made from fabricating sheet metal or plastic molding.

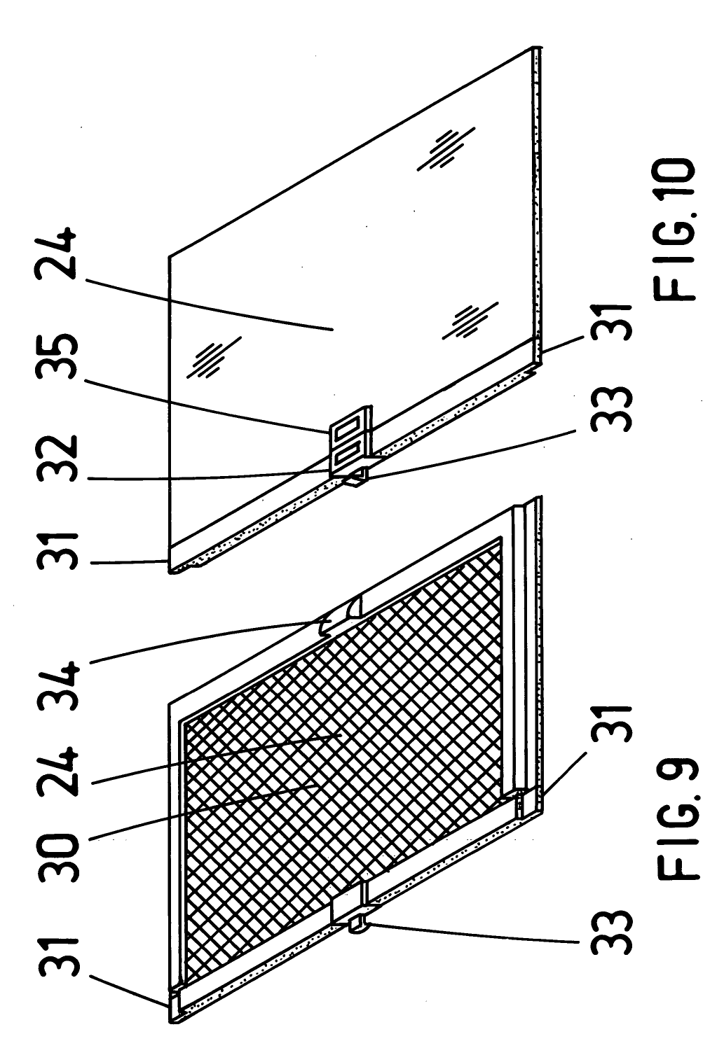

The first planar piece 19 is made of a solid metal or plastic panel that fits nicely within the inner spacing 28 of second planar piece 20. A substantially large central area of first planar piece 19 is constructed of a sun screen 30 similar to that of first preferred embodiment of present invention. The front section of first planar piece 19 is extended outside of the front side opening 29 of the second planar piece 20 when first and second planar pieces 19 & 20 are interposed into a coupled unit as shown in FIG. 9 and FIG. 10. The extended front section of first planar piece 19 is provided with a guide 3 land a first pull handle 32. The guide 31 is a lateral and downward projectile of first planar piece 19 that fits within the second pair of parallel tracks. The guide 31 allows the front end of the first planar piece 19 to slide in the second pair of parallel tracks when first planar piece 19 slides in and out of inner spacing 28 of second planar piece 20 through the front side opening 29 of second planar piece 20. The first pull handle 32 is embedded in the bottom surface of first planar piece 19. Preferably, a locking mechanism 33 is incorporated into the first pull handle 32.

The second planar piece 20 is provided with a latch 34 and a second pull handle 35. The latch 34 is a upward projectile of second planar piece 20. The latch 34 is to be engaged with a catcher (not shown) in the motor driven glass pane when the glass pane is motor driven rearward toward an open position. Consequently, second planar piece 20 and glass pane move rearward simultaneously. The second pull handle 35 is embedded in the bottom surface of bottom wall 24 of second planar piece 20.

The ventilator-glare screen unit of second preferred embodiment of present invention is operable in a closing mode when first and second planar pieces 19 and 20 are aligned and interposed vertically into the coupled unit as shown in FIG. 9 (i.e. top view) and FIG. 10 (i.e. bottom view). In such coupled unit, sun screen 30 is entirely blocked by bottom wall 24 of second planar piece 20 that prohibits air venting and sun light transmission through the coupled unit.

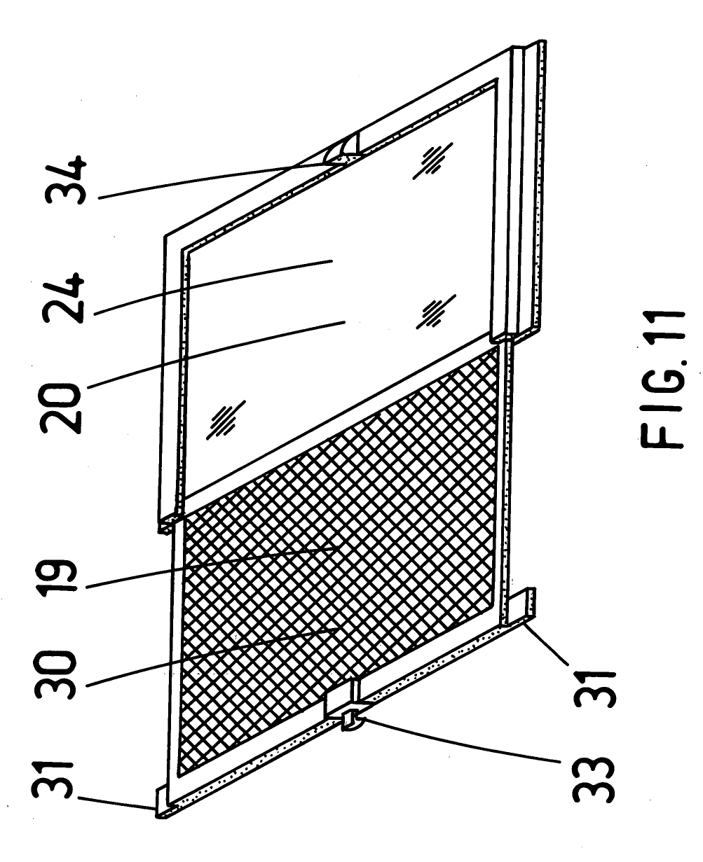

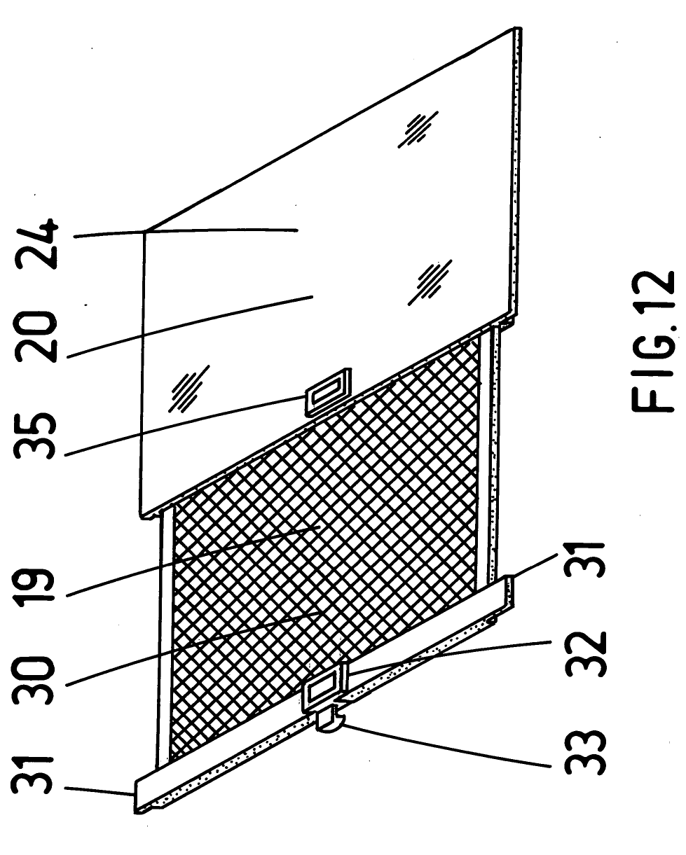

The ventilator-glare screen unit of second preferred embodiment of present invention is operable in an opening mode as a de-coupled unit as shown in FIG. 11 (i.e. top view) and FIG. 12 (i.e. bottom view). Wherein, the first and second planar pieces 19 and 20 are positioned offset to allow air venting and sun light transmission through sun screen 30.

It is understood that sun screen 30, guide 31, latch 34, first pull handle 32, second pull handle 35, and locking mechanism 33 can be constructed in various configuration for use in the present invention. Any such variation is considered within the scope of present invention.

The ventilator-glare screen unit according to the second preferred embodiment of present invention is operable in a closing mode above interior roof opening, in which, first planar piece 19 is moved forward to a first front-limit position, and second planar piece 20 is moved forward to a second front-limit position. The first and second planar pieces 19 & 20 are aligned and interposed vertically into the coupled unit directly above interior roof opening that covers the entire interior roof opening. Therefore, air venting and sun light transmission through interior roof opening are prohibited. The second pair of parallel tracks is provided with a first stopper that prevents first planar piece 19 from moving forward beyond the first front-limit position.

Ventilator-glare screen unit according to the second preferred embodiment of present invention is operable in a stowed mode above said interior roof opening, in which, first planar piece 19 is moved rearward to a first rear-limit position, and second planar piece 20 is moved rearward to a second rear-limit position. The first and second planar pieces 19 & 20 are aligned and interposed vertically into a coupled unit that is positioned offset from interior opening. Therefore, interior roof opening is left open, and air venting and sun light transmission through interior roof opening are allowed. The second pair of parallel tracks is provided with a second stopper that prevents second planar piece 20 from moving rearward beyond the second rear-limit position.

Ventilator-glare screen unit according to the second preferred embodiment of present invention is operable in an opening mode above said interior roof opening, in which, first planar piece 19 is moved forward to a first front-limit position directly above interior roof opening, and second planar piece 20 is moved rearward to a second rear-limit position offset from interior roof opening. In the opening mode, sun screen 30 of first planar piece 19 is positioned directly above interior roof opening, and the second planar piece 20 is positioned offset from sun screen 30 and from interior roof opening. Therefore, air venting and sun light transmission are allowed through sun screen 30 of first planar piece, and through interior roof opening successively.

Ventilator-glare screen unit according to the second preferred embodiment of present invention is operable:

(1). from closing mode to stowed mode by pulling first pull handle 32 rearward so that first and second planar pieces 19 and 20 are moved rearward simultaneously as a coupled unit.

(2). from stowed mode to closing mode by pulling second pull handle 35 forward so that first and second planar pieces 19 and 20 are moved forward simultaneously as a coupled unit.

(3). from closing mode to opening mode by pulling second pull handle 35 rearward, provided glass pane is operated at close position. Ventilator-glare screen unit is operable from closing mode to opening mode automatically without any manual action, provided glass pane is actuated and motor driven to open position.

(4). from opening mode to closing mode by pulling second pull handle 35 forward.

(5). from opening mode to stowed mode by pulling first pull handle 32 rearward. Locking mechanism 33 is automatically released as first pull handle 32 being pulled rearward.

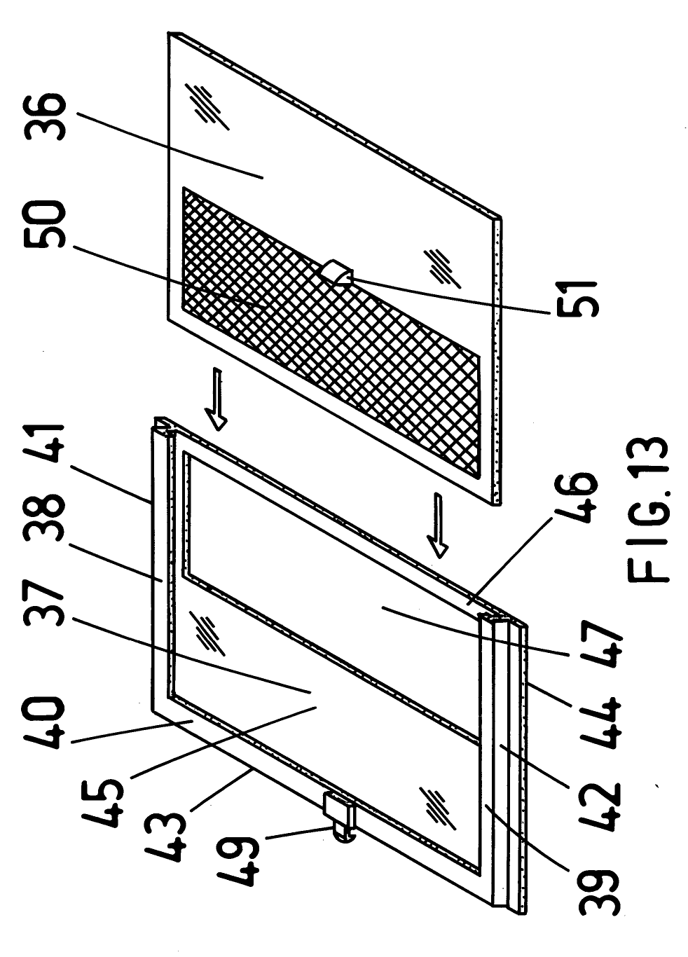

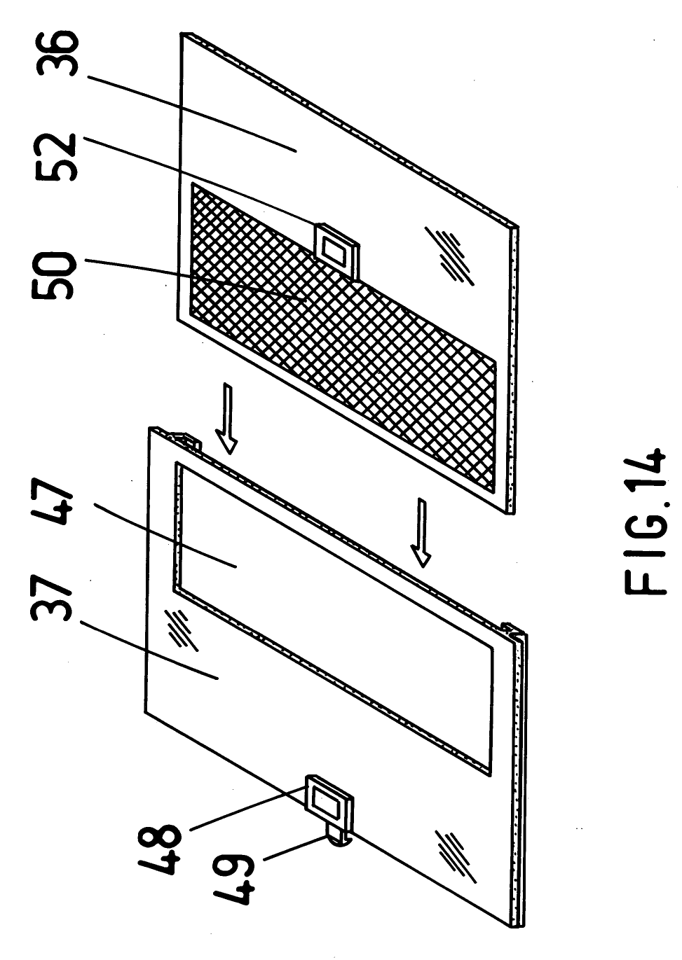

The third preferred embodiment of the ventilator-glare screen unit of present invention is represented in FIG. 13 through FIG. 18. FIG. 13 and FIG. 14 respectively show a top and bottom perspective views of the third preferred embodiment of the ventilator-glare screen unit of present invention in a dissembled state. The ventilator-glare screen unit comprises of a first planar piece 36 and a second planar piece 37, which are independently slidable in a second pair of parallel tracks mounted in the roof of vehicle (not shown).

The second planar piece 37 is made of an integral housing structure with a right top wall 38, a left top wall 39, a front top wall 40, a right side wall 41, a left side wall 42, a front side wall 43 and a bottom wall 44 which are integrally connected to envelope an inner spacing 45 and a rear side opening 46. The bottom wall 44 is in a substantially rectangular shape and in a size substantially equivalent to that of interior roof opening. The bottom wall 44 is about equally divided into a front section and a rear section. A substantially large central area in the rear section is cut off with a bottom wall opening 47. The first planar piece 36 is slidable in and out of the inner spacing 45 of second planar piece 37 through the rear side opening 46. The second planar piece 37 is slidable in the second pair of parallel tracks by pulling a second pull 48 embedded in the bottom surface of bottom wall 44. Preferably, a locking mechanism 49 is incorporated into the second pull handle 48. The entire housing structure of second planar piece 37 can be made from fabricating sheet metal or plastic molding.

The first planar piece 36 is made of a solid metal or plastic panel that fits nicely within inner spacing 45 of second planar piece 37. The first planar piece 36 is equally divided into a front section and a rear section. A substantially large central area in the front section of first planar piece 36 is replaced with a sun screen 50 similar to that of first preferred embodiment of present invention. The first planar piece 36 is provided with a latch 51 and a first pull handle 52. The latch 51 is an upward projectile of first planar piece 36. The latch 51 is to be engaged with a catcher in the motor driven glass pane when the glass pane is motor driven rearward toward an open position. Consequently, first planar piece 36 and glass pane moves rearward simultaneously. The first pull handle 52 is centrally embedded in the bottom surface of first planar piece 36.

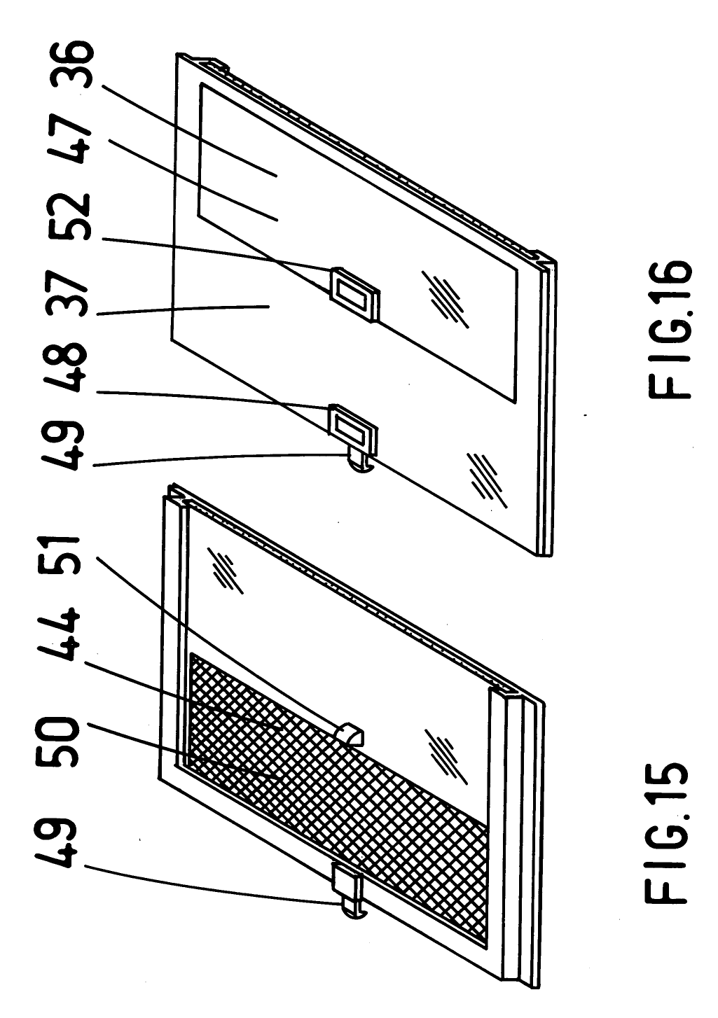

The ventilator-glare screen unit of third preferred embodiment of present invention is operable in a closing mode when first and second planar pieces 36 and 37 are aligned and interposed vertically into the coupled unit as shown in FIG. 15 (i.e. top view) and FIG. 16 (i.e. bottom view). In such coupled unit, sun screen 50 of first planar piece 36 being positioned offset from the bottom wall opening 47 of the second planar piece 37, and the bottom wall 44 of second planar piece 37 blocks the entire sun screen 50. Therefore, air venting and sun light transmission through the coupled unit are prohibited. The coupled unit is in a size that is sufficient to cover the entire interior roof opening.

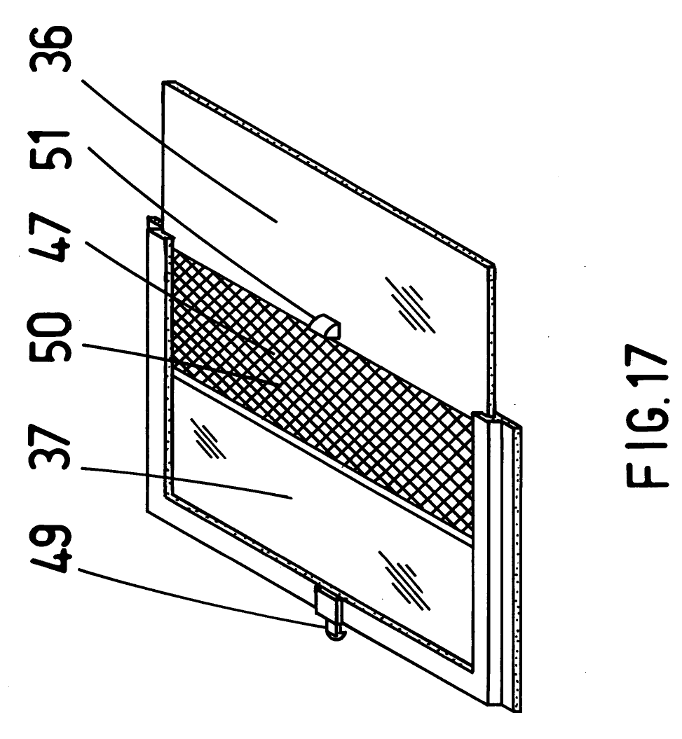

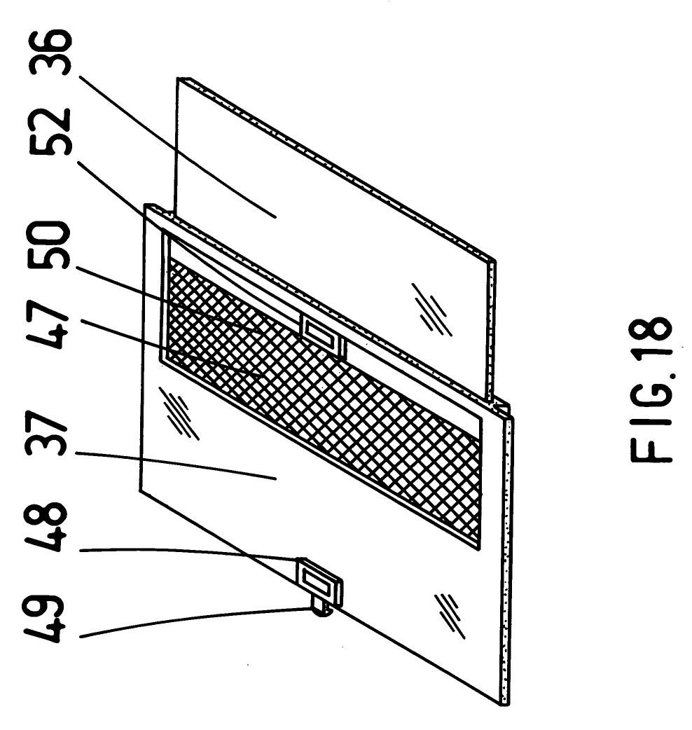

The ventilator-glare screen unit of third preferred embodiment of present invention is operable in an opening mode as a de-coupled unit as shown in FIG. 17 (i.e. top view) and FIG. 18 (i.e. bottom view), in which first and second planar pieces 36 and 37 are positioned offset to allow air venting and sun light transmission through sun screen 50 and bottom wall opening 47 successively.

It is understood that sun screen 50, latch 51, first pull handle 52, second pull handle 48, and locking mechanism 49 can be constructed in various configuration for use in the present invention. Such variation is considered within the scope of present invention.

Ventilator-glare screen unit according to the third preferred embodiment of present invention is operable in a closing mode above interior roof opening, in which, first planar piece 36 is moved forward to a first front-limit position, and second planar piece 37 is moved forward to a second front-limit position. The first and second planar pieces 36 & 37 are aligned and interposed vertically into the coupled unit directly above interior roof opening that covers the entire interior roof opening. The second pair of parallel tracks is provided with a first stopper that prevents second planar piece 37 from moving forward beyond the second front-limit position.

Ventilator-glare screen unit according to the third preferred embodiment of present invention is operable in a stowed mode above interior roof opening, in which, first planar piece 36 is moved rearward to a first rear-limit position, and second planar piece 37 is moved rearward to a second rear-limit position. The first and second planar pieces 36 and 37 are aligned and interposed vertically into a coupled unit that is positioned offset from interior opening. Therefore, interior roof opening is left open, and air venting and sun light transmission through interior roof opening are not prohibited. The second pair of parallel tracks is provided with another stopper that prevents first planar piece from moving rearward beyond the first rear-limit position.

Ventilator-glare screen unit according to the third preferred embodiment of present invention is operable in an opening mode above interior roof opening, in which, first planar piece 36 is moved rearward to a first rear-limit position, and second planar piece 37 is moved forward to a second front-limit position. In the opening mode, sun screen 50 of first planar piece 36 is positioned directly above the bottom wall opening 47 of second planar piece 37, and bottom wall opening 47 of second planar piece 37 is positioned directly above the interior roof opening. Therefore, air venting and sun light transmission are allowed through sun screen 50 of first planar piece 36, through bottom wall opening 47 of second planar piece 37, and through interior roof opening successively.

Ventilator-glare screen unit according to the third preferred embodiment of present invention is operable:

(1). from closing mode to stowed mode by pulling second pull handle 48 reward so that first and second planar pieces are moved rearward simultaneously as a coupled unit.

(2). from stowed mode to closing mode by pulling second pull handle 48 forward so that first and second planar pieces are moved forward simultaneously as a coupled unit.

(3). from closing mode to opening mode by pulling first pull handle 52 reward, provided glass pane is operated at close position.

(4). from closing mode to opening mode automatically without any manual action, provided glass pane being actuated and motor driven to open position.

(5). from opening mode to closing mode by pulling first pull handle 52 forward.

(6). from opening mode to stowed mode by pulling second pull handle 48 rearward.

In summary, the ventilator-glare screen unit of present invention enables the sun roof assembly to be operable in the following operation modes:

(1). The first closing mode that glass pane is at close position, and ventilator-glare screen unit is at the closing mode. In this mode, air venting and sun light transmission through sun roof assembly are prohibited.

(2). The second closing mode that glass pane is at close position, and ventilator-glare screen unit is at the stowed mode. In this mode, air venting through sun roof assembly is prohibited, but interior of vehicle is subject to fill sun light exposure.

(3). The third closing mode that glass pane is at close position, and ventilator-glare screen unit is at the opening mode. In this mode, air venting through sun roof assembly is prohibited, but interior of vehicle is subject to moderate sun light exposure.

(4). The first opening mode that glass pane is at open position, and ventilator-glare screen unit is at the stowed mode. In this mode, interior of vehicle is subject to full blow of air flow and full sun light exposure during driving.

(5). The second opening mode that glass pane is at open position, and ventilator-glare screen unit is at the opening mode. In this mode, interior of vehicle is subject to moderate air venting and moderate sun light exposure during driving. Since the ventilator-glare screen unit is provided with a locking mechanism, this mode can provide essential air venting for a parked car without a security concern.

(6). The first vent mode that glass pane is at vent position, and ventilator-glare screen unit is at the stowed mode. In this mode, interior of vehicle is subject to minimum air venting but full sun light exposure.

(7). The second vent mode that glass pane is at vent position, and ventilator-glare screen unit is at the opening mode. In this mode, interior of vehicle is subject to minimum air venting but moderate sun light exposure.

What is claimed is:

1. A ventilator-glare screen unit operable in conjunction with a motor driven glass pane in a sun roof assembly in a vehicle, wherein:
Said vehicle having an exterior roof opening and an interior roof opening in a substantially rectangular shape; and
Said motor driven glass pane having a substantially rectangular glass pane slidable in a first pair of parallel tracks mounted in the roof of said vehicle; and said glass pane operable at a close position to cover said exterior roof opening, at an open position to uncover said exterior roof opening, and at a vent position with the rear end of said glass pane being tilted upward to uncover said exterior roof opening; and
Said ventilator-glare screen unit comprising of a first and a second planar pieces independently slidable in a second pair of parallel tracks mounted in the roof of said vehicle, in which, said first and second planar pieces having a substantially rectangular shape and size substantially equivalent to that of said interior roof opening, and said first planar piece having a sun screen that provides numbers of vent holes for air venting while partially blocks sun light transmission; and
Said ventilator-glare screen unit operable in a closing mode above said interior roof opening, in which, said first planar piece being moved forward to a first front-limit position, said second planar piece being moved forward to a second front-limit position, said first and second planar pieces being aligned and interposed vertically into a coupled unit, and said coupled unit being positioned directly above said interior roof opening so that air venting and sun light transmission through said interior roof opening being prohibited; and
Said ventilator-glare screen unit operable in a stowed mode above said interior roof opening, in which, said first planar piece being moved rearward to a first rear-limit position, said second planar piece being moved rearward to a second rear-limit position, said first and second planar pieces being aligned and interposed vertically into said coupled unit, and said coupled unit being positioned offset from said interior opening so that air venting and sun light transmission through said interior roof opening being allowed; and
Said ventilator-glare screen unit operable in an opening mode above said interior roof opening, in which, said first and second planar pieces being positioned offset from each other, said sun screen in said first planar piece being positioned directly above said interior roof opening so that air venting and sun light transmission being allowed through said sun screen and said interior roof opening successively; and
Said sun roof assembly operable in a first closing mode, in which, said glass pane being operated at said close position, and said ventilator-glare screen unit being operated in said closing mode; and
Said sun roof assembly operable in a second closing mode, in which, said glass pane being operated at said close position, and said ventilator-glare screen unit being operated in said stowed mode; and
Said sun roof assembly operable in a third closing mode, in which, said glass pane being operated at said close position, and said ventilator-glare screen unit being operated in said opening mode; and
Said sun roof assembly operable in a first opening mode, in which, said glass pane being operated at said open position, and said ventilator-glare screen unit being operated in said stowed mode; and
Said sun roof assembly operable in a second opening mode, in which, said glass pane being operated at said open position, and said ventilator-glare screen unit being operated in said opening mode; and
Said sun roof assembly operable in a first vent mode, in which, said glass pane being operated at said vent position, and said ventilator-glare screen unit being operated in said stowed mode; and
Said sun roof assembly operable in a second vent mode, in which, said glass pane being operated at said vent position, and said ventilator-glare screen unit being operated in said opening mode.

2. The ventilator-glare screen unit according to claim 1, wherein:
Said first planar piece comprising of an integral housing structure having a top wall, a bottom wall, a front wall, a right side wall, and a left side wall that are integrally connected to envelope an inner spacing with a rear side opening; and said top and bottom walls having a substantially rectangular shape and size substantially equivalent to that of said interior roof opening; and a substantially large central area of said top wall being removed and replaced with said sun screen; and a substantially large central area of said bottom wall being removed and replaced with a bottom opening; and
Said second planar piece comprising of a solid panel being fit nicely within said inner spacing of said first planar piece when said first and second planar pieces being aligned and interposed vertically into said coupled unit; and said second planar piece slidable in and out of said inner spacing of said first planar piece through said rear side opening of said first planar piece; and
Said ventilator-glare screen unit operable in said opening mode above said interior roof opening, in which, said first planar piece being moved forward to said first front-limit position directly above said interior roof opening; and said second planar piece being moved rearward to said second rear-limit position offset from said interior roof opening; and said ventilator-glare screen unit providing air venting and sun light transmission through said sun screen, said bottom opening of said first planar piece, and said interior roof opening successively.

3. The ventilator-glare screen unit according to claim 1, wherein:
Said second planar piece comprising of an integral housing structure having a right top wall, a left top wall, a rear top wall, a bottom wall, a right side wall, a left side wall and a rear side wall that are integrally connected to envelope an inner spacing with a top and front side openings; and said bottom wall having a substantially rectangular shape and size substantially equivalent to that of said interior roof opening; and
Said first planar piece comprising of a solid panel being fit nicely within said inner spacing of said second planar piece when said first and second planar pieces being aligned and interposed vertically into said coupled unit; and said first planar piece slidable in and out of said inner spacing of said second planar piece through said front side opening of said second planar piece; and a substantially large central area of said first planar piece being removed and replaced with said sun screen; and
Said ventilator-glare screen unit operable in said opening mode above said interior roof opening, in which, said first planar piece being moved forward to said first front-limit position directly above said interior roof opening; and said second planar piece being moved rearward to said second rear-limit position offset from said interior roof opening;
and said ventilator glare-screen unit providing air venting and sun light transmission through said sun screen and said interior roof opening successively.

4. The ventilator-glare screen unit according to claim 1, wherein:
Said second planar piece comprising of an integral housing structure having a right top wall, a left top wall, a front top wall, a bottom wall, a right side wall and a left side wall and a front side wall that are integrally connected to envelope an inner spacing with a top and rear side openings; and said bottom wall having a substantially rectangular shape and size substantially equivalent to that of said interior roof opening; and a rear section of said bottom wall equivalent to a half of total area of said bottom wall being removed and replaced with a bottom opening; and
Said first planar piece comprising of a solid panel being fit nicely within said inner spacing of said second planar piece when said first and second planar pieces being aligned and interposed vertically into said coupled unit; and said first planar piece slidable in and out of said inner spacing of said second planar piece through said rear side opening of said second planar piece; and a front section of said first planar piece equivalent to a half of total area of said first planar piece being removed and replaced with said sun screen; and said sun screen of said first planar piece being offset from said bottom opening of said second planar piece when said first and second planar pieces being aligned and interposed vertically into said coupled unit, so that air venting and sun light transmission through said coupled unit being prohibited; and
Said ventilator-glare screen unit operable in said opening mode above said interior roof opening, in which, said second planar piece being moved forward to said second front-limit position directly above said interior roof opening; and said first planar piece being moved rearward to a third rear-limit position so that said sun screen of said first planar piece being positioned directly above said bottom opening of said second planar piece, and said sun screen of said first planar piece and said bottom opening of said second planar piece being positioned directly above said interior roof opening; and said ventilator-glare screen unit providing air venting and sun light transmission through said sun screen of said first planar piece, said bottom opening of said second planar piece, and said interior roof opening successively.

5. The ventilator-glare screen unit according to claim 2, wherein:
Said second pair of parallel tracks having a first stopper that preventing said first planar piece from moving forward beyond said first front-limit position, and having a second stopper that preventing said second planar piece from moving rearward beyond said second rear-limit position.

6. The ventilator-glare screen unit according to claim 2, wherein:
Said second planar piece and said glass pane having a latch and a catcher respectively; and said sun roof assembly operable from said first closing mode to said second opening mode, in which, said latch and catcher being engaged while said glass pane being motor driven rearward to said open position, and said second planar piece being simultaneously pushed rearward to said second rear-limit position.

7. The ventilator-glare screen unit according to claim 2, wherein:
Said first and second planar pieces having a first and second pull handles respectively; and
Said ventilator-glare screen unit operable from said closing mode to said stowed mode by pulling said first pull handle rearward so that said first and second planar pieces being moved rearward simultaneously; and
Said ventilator-glare screen unit operable from said stowed mode to said closing mode by pulling said second pull handle forward so that said first and second planar pieces being moved forward simultaneously; and
Said ventilator-glare screen unit operable from said closing mode to said opening mode by pulling said second pull handle rearward; and
Said ventilator-glare screen unit operable from said opening mode to said closing mode by pulling said second pull handle forward; and
Said ventilator-glare screen unit operable from said opening mode to said stowed mode by pulling said first pull handle rearward.

8. The ventilator-glare screen unit according to claim 2, wherein:
Said second planar piece having a pair of guides slidable in said second pair of parallel tracks while said second planar piece sliding in and out of said inner spacing of said first planar piece housing structure.

9. The ventilator-glare screen unit according to claim 7, wherein:
Said first planar piece having a locking mechanism incorporated into said first pull handle in said first planar piece; and
Said locking mechanism capable of automatically locking said first planar piece at said first front-limit position while said first planar piece being pulled forward to said first front-limit position; and
Said locking mechanism capable of being automatically released while said first pull handle being pulled rearward.

10. The ventilator-glare screen unit according to claim 3, wherein:
Said second pair of parallel tracks having a first stopper that preventing said first planar piece from moving forward beyond said first front-limit position, and having a second stopper that preventing said second planar piece from moving rearward beyond said second rear-limit position.

11. The ventilator-glare screen unit according to claim 3, wherein:
Said second planar piece and said glass pane having a latch and a catcher respectively; and said sun roof assembly operable from said first closing mode to said second opening mode, in which, said latch and catcher being engaged while said glass pane being motor driven rearward to said open position, and said second planar piece being simultaneously pushed rearward to said second rear-limit position.

12. The ventilator-glare screen unit according to claim 3, wherein:
Said first and second planar pieces having a first and second pull handles respectively; and
Said ventilator-glare screen unit operable from said closing mode to said stowed mode by pulling said first pull handle rearward so that said first and second planar pieces being moved rearward simultaneously; and
Said ventilator-glare screen unit operable from said stowed mode to said closing mode by pulling said second pull handle forward so that said first and second planar pieces being moved forward simultaneously; and
Said ventilator-glare screen unit operable from said closing mode to said opening mode by pulling said second pull handle rearward; and
Said ventilator-glare screen unit operable from said opening mode to said closing mode by pulling said second pull handle forward; and
Said ventilator-glare screen unit operable from said opening mode to said stowed mode by pulling said first pull handle rearward.

13. The ventilator-glare screen unit according to claim 3, wherein:
Said first planar piece having a pair of guides slidable in said second pair of parallel tracks while said first planar piece sliding in and out of said inner spacing of said second planar piece housing structure.

14. The ventilator-glare screen unit according to claim 12, wherein:
Said first planar piece having a locking mechanism incorporated into said first pull handle in said first planar piece; and
Said locking mechanism capable of automatically locking said first planar piece at said first front-limit position while said first planar piece being pulled forward to said first front-limit position; and
Said locking mechanism capable of being automatically released while said first pull handle being pulled rearward.

15. The ventilator-glare screen unit according to claim 4, wherein:
Said second pair of parallel tracks having a first stopper that preventing said first planar piece from moving rearward beyond said first rear-limit position, and having a second stopper that preventing said second planar piece from moving forward beyond said second front-limit position.

16. The ventilator-glare screen unit according to claim 4, wherein:
Said first planar piece and said glass pane having a latch and a catcher respectively; and said sun roof assembly operable from said first closing mode to said second opening mode, in which, said latch and catcher being engaged while said glass pane being motor driven rearward to said open position, and said first planar piece being simultaneously pushed rearward to said third rear-limit position.

17. The ventilator-glare screen unit according to claim 4, wherein:
Said first and second planar pieces having a first and second pull handles respectively; and
Said ventilator-glare screen unit operable from said closing mode to said stowed mode by pulling said second pull handle rearward so that said first and second planar pieces being moved rearward simultaneously; and
Said ventilator-glare screen unit operable from said stowed mode to said closing mode by pulling said second pull handle forward so that said first and second planar pieces being moved forward simultaneously; and
Said ventilator-glare screen unit operable from said closing mode to said opening mode by pulling said first pull handle rearward; and
Said ventilator-glare screen unit operable from said opening mode to said closing mode by pulling said first pull handle forward; and
Said ventilator-glare screen unit operable from said opening mode to said stowed mode by pulling said second pull handle rearward.

18. The ventilator-glare screen unit according to claim 17, wherein:
Said second planar piece having a locking mechanism incorporated into said second pull handle in said second planar piece; and
Said locking mechanism capable of automatically locking said second planar piece at said second front-limit position while said second planar piece being pulled forward to said second front-limit position; and
Said locking mechanism capable of being automatically released while said second pull handle being pulled rearward.

19. The ventilator-glare screen unit according to claim 1, wherein said sun screen is made of rigid wire cloth.

20. The ventilator-glare screen unit according to claim 1, wherein said sun screen is made of integral part of said first planar piece that has numbers of vent holes penetrating through.

21. The ventilator-glare screen unit according to claim 1, wherein said sun screen is supported and reinforced by a cross bar framing structure.
